(19) United States
(12) Patent Application Publication
(10) Pub. No.: US 2011/0109628 A1
(43) Pub. Date: May 12, 2011

(54) METHOD FOR PRODUCING AN EFFECT ON VIRTUAL OBJECTS

(76) Inventor: Oleg Stanislavovich Rurin, Moscow (RU)

(21) Appl. No.: 13/001,418

(22) PCT Filed: Jun. 24, 2008
(86) PCT No.: PCT/RU08/00392

§ 371 Date: Dec. 24, 2010

(51) Int. Cl. G06T 15/00

(52) U.S. Cl. 345/420

(57) ABSTRACT

A method of affecting the virtual objects, disposing a first group of blocks of identification in real three-dimensional space; shaping, in real three-dimensional space, the real physical base system of the coordinates fixed to a space position of blocks of identification of the first group; spotting coordinates of working area of displays in real three-dimensional space relative to the real physical base system of coordinates; setting coordinates of three-dimensional virtual objects created in advance in digital format in real three-dimensional space relative to the real physical base system of the coordinates, wherein disposing the second group of blocks of the identification, setting in real three-dimensional space a position of a fixing point of the virtual pointer, and spotting coordinates of a fixing point of the virtual pointer in real three-dimensional space regarding the real physical system of coordinates; setting, with necessary detailing, of a coordinate of a collection of a geometrical place of points of the virtual pointer relative to a fixing point of the virtual pointer; spotting in real three-dimensional space relative to the real physical base system of coordinates with necessary detailing of coordinate of a collection of a geometrical place of points of the virtual pointer, hitting, in a field of coordinates of working area of displays; shaping a collection of the virtual objects whose coordinates in real three-dimensional space hit in the field calculated, taking into account layout of a geometrical location of points of the virtual pointer, coordinates of working area of displays hitting in field; performing the preset virtual operations on modification of virtual objects from the generated collection of virtual objects.

### CROSS REFERENCE TO RELATED APPLICATIONS

This application is a U.S. National Phase of PCT/RU2008/000392, filed on Jun. 24, 2008, the entire contents of which are hereby incorporated by reference.

### BACKGROUND OF THE INVENTION

The invention relates to the field of information and computer technologies, and more particularly, to data input entry devices and means of controlling virtual objects in a virtual three-dimensional space represented on a screen of a monitor or a similar display unit. The proposed method allows exercising control of virtual objects in a virtual three-dimensional space by linking the implemented operations to the coordinates of the real three-dimensional space.

In the conventional art, U.S. Pat. No. 6,057,827 teaches self-acting positioning of the indicator (cursor, pointer) for three-dimensional computer modeling, in which the user can position the indicator around a two-dimensional geometrical location of the points representing a three-dimensional screen object of the screen monitor. According to this reference, the indicator automatically moves to the geometrical place of points setting the three-dimensional object, the nearest to the layout of the indicator set by the cursor on the screen set by the user. However, in this method, an exact positioning of the indicator is a challenge, as in many cases it is difficult, on the basis of the two-dimensional plane map, to estimate the correct spatial arrangement of objects of virtual space and, for the user, to correctly take up a position the indicator. Additional errors at a stage of a self-acting selection of the three-dimensional virtual object are also possible. This leads to a need to repeat the process of cursor positioning, and hampers operation of the user.

A computerized method and a computer system of positioning the indicator is known (see U.S. Patent Publication No. 2006/0244745), in which the user, at a time of indicator positioning in three-dimensional virtual space, can watch an algorithmically created three-dimensional image on a two-dimensional display, and can take into account the gained additional information of a depth of the map. This allows to take up a position the indicator in three-dimensional virtual space more precisely and to implement positioning with a few attempts. The drawback of this method is in that the three-dimensional image, appearing on a two-dimensional display, is generated on the basis of the dynamic depth affect (see H. Wallach et al., “The kinetic depth effect”, Journal of Experimental Psychology, 45, 205-217). Using forced animation of the displayed objects for implementing a space image is an artificial method, which is applicable only to highly specialized tasks (for example, three-dimensional mathematical modeling or synthesis of three-dimensional objects), and requires additional time and operational resources for its implementation. In the real-time systems, simulators, game applications use of such method is far from being effective.

Also, the common drawback of methods described in U.S. Pat. No. 6,057,827 and U.S. Patent Publication No. 2006/0244745 is in that these methods are based on controlling objects of the virtual three-dimensional space on the two-dimensional plane of the display unit, without linking the current operations to the coordinates of the real three-dimensional space.

The problem to be solved by the present invention is in developing a method of producing effect on virtual objects of a three-dimensional virtual space, where the control impact on the objects of the three-dimensional virtual space is effected with regard to the exact measurable (and subsequently calculated) information on a relative disposition of the user, the display and the objects of the virtual space in the real physical three-dimensional coordinate system—the base system of coordinates.

The problem is solved by producing an effect on virtual objects, including the operations of:
disposing, in the real three-dimensional space, a first group of identification blocks;
composing, in the real three-dimensional space, the real physical base system of coordinates linked to the spatial position of identification blocks of the first group;
determining the coordinates of the working zone/area (operational range) of displays in the real three-dimensional space, regarding the real physical base system of coordinates;
setting the coordinates of three-dimensional virtual objects created in advance in the digital format in the real three-dimensional space relative to the real physical base system of coordinates;
disposing the second group of identification blocks, which sets the position of the fixing point of the virtual pointer (marker, cursor) in real three-dimensional space, and determines the coordinates of the fixing point of the virtual pointer in the real three-dimensional space regarding the real physical base system of coordinates;
setting, with necessary details (i.e., with sufficient number of polygons needed to display it), the coordinate of the constellation of geometrical positions of the virtual pointer points regarding the fixing point of the virtual pointer;
determining, with necessary details, in the real three-dimensional space regarding the real physical base system of coordinates, the coordinates of the constellation of geometrical positions of the virtual pointer points, located in the area of coordinates of the working area of a display;
composing a set of the virtual objects whose coordinates, in the real three-dimensional space, fall within the area calculated with regard to the layout of the geometrical positions of the virtual pointer points, with those points falling within the working area of a display;
performing the preset virtual operations to modify the virtual objects for all, or some of, objects in the such composed set of the virtual objects.

The main difference between the proposed method and the prior art methods of positioning the indicator on the objects of three-dimensional virtual space, is in that the indicator (according to the proposed method) is positioned in the real physical base system of coordinates, and all objects of the three-dimensional virtual space, as well as the display unit, also have the specific coordinates set in this real physical base system of coordinates or converted to a real physical coordinate system.

Thus, the technical result includes development of a positioning method for the indicator controlling the objects of the virtual three-dimensional space, whose position is set precisely in a physical coordinate system, instead of a simulated one, i.e., on the two-dimensional plane of the display, and the control by means of the indicator is performed with respect of those virtual objects of the three-dimensional virtual space whose equivalent, physical coordinates fall within the operational range of the indicator. Such new features of the claimed indicator greatly expand the scope of application of the claimed method due to possibility of developing high-precision simulators of physical processes with the highest degree of reliability at cloning the space operations in the three-dimensional virtual space, in particular, movement, relocation, rotation and other effects in connection with virtual objects.

The method of producing an effect on virtual objects, according to the claimed invention, has the value of its own; however, an important application of the proposed method is in its combination with adaptive generation of a displayed array of virtual objects on the basis of the analysis of the observer position. For this purpose, a third group of blocks of identification is disposed, which sets the position of a view point of the working area of the user display in real three-dimensional space linked to the real physical base system of coordinates; an array of mapped (displayed) data is modified by means of inserting the mapped (displayed) collection of a geometrical location of points of the virtual pointer, and a current array of displayed three-dimensional virtual objects is composed, on the basis of:
information on a relative position, in real the three-dimensional space, regarding the real physical base system of coordinates, of the complete collection of the three-dimensional virtual objects, modified taking into account the performed collection of the preset virtual operations and the position (location) of the mapped (displayed) part of the virtual pointer;
information on the position of the user view point of the working area of the display;
information on the position of the working area of the display;
the generated array is then transmitted to the display.

The sequence of operations set forth above allows to achieve an effect similar to browsing of a virtual three-dimensional space through a normal window, whose role is played by the display screen, and the manipulation of virtual objects by means of the indicator is, also, performed through that “window”. This gives the user a chance to control those objects of the virtual world that are located both immediately in front of the “window”, and to the right, or to the left of the “window”, as well as the objects located at various distances from the “window”.

The method of producing effect on the objects of the virtual world, the examples of calculation of coordinates of physical and virtual objects, and also an example of a procedure for establishing one-to-one correspondence between the virtual coordinates and the real physical coordinates of the base system are considered below.

The invention is explained with reference to the graphics materials using a version of practical implementation of the proposed method within the framework of the system containing hardware necessary for setting a base system of coordinates and identifying position of physical objects, such as: the user, the means of uploading information by the user, the display unit, and also including necessary algorithmic and program solutions which perform the set of operations over the material objects (hardware), necessary for implementation of the proposed method.

### BRIEF DESCRIPTION OF THE ATTACHED DRAWINGS

FIG. 1 shows a general arrangement of system of visualization of three-dimensional objects of virtual space and an example of a display circuit of the virtual pointer for the case where the indicator transits through the working area of a display.

FIG. 2 shows an example of a display circuit of the virtual pointer for the case where the virtual pointer transits to the side the working area of a display.

FIG. 3 shows a flowchart of the algorithm of implementation of the method for producing an effect on virtual objects.

FIG. 4 shows an example of determination of a spatial position of the object (indicator) using the images from two video- or photo-cameras.

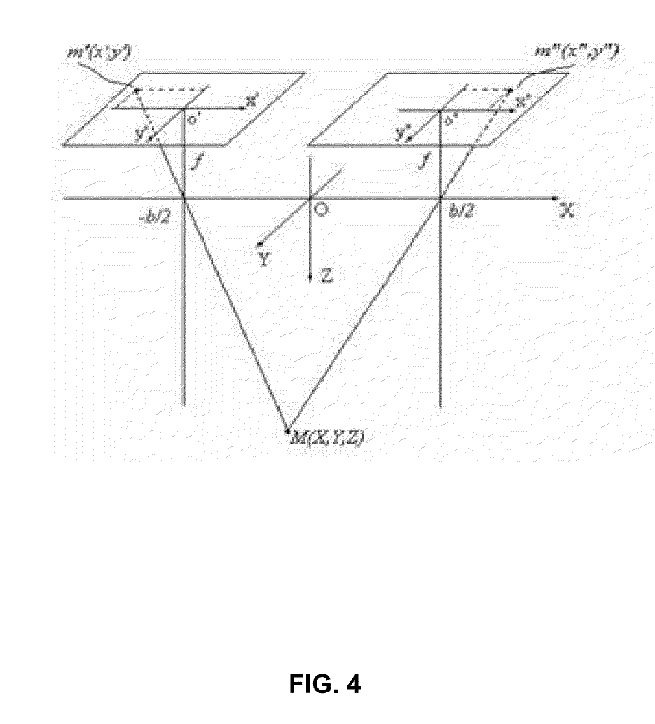

### DETAILED DESCRIPTION OF THE PREFERRED EMBODIMENTS

Reference will now be made in detail to the preferred embodiments of the present invention, examples of which are illustrated in the accompanying drawings.

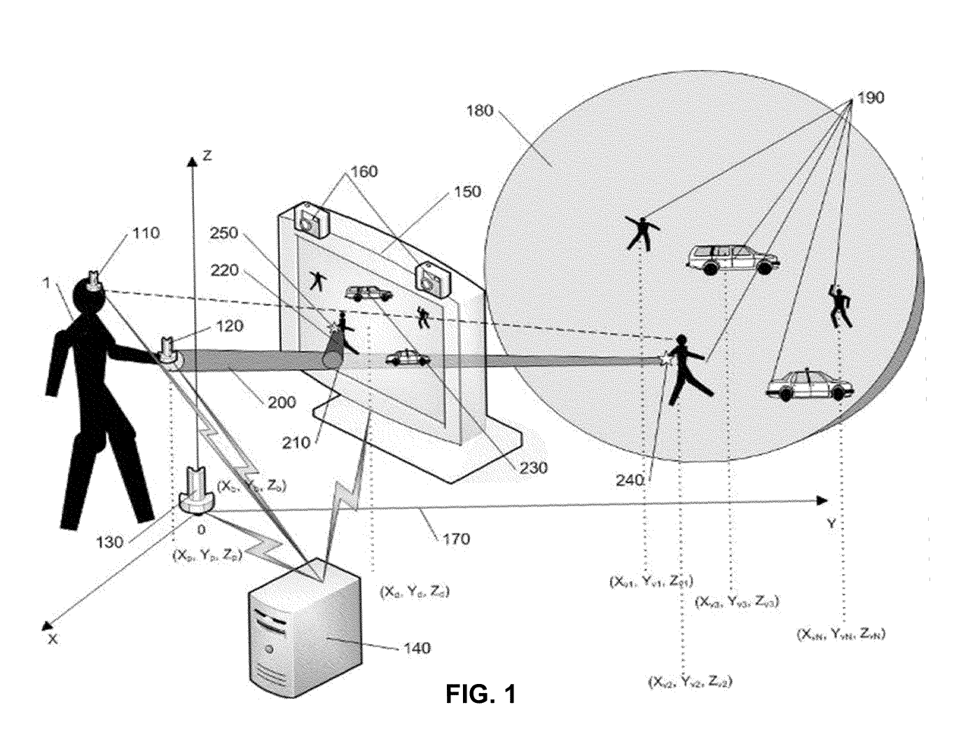

On FIG. 1 an example is shown of interaction of the user 1 with the system containing a third group of identification blocks 110, fixed on the head of the user 1, the second group of identification blocks 20, fixed on the body of the user 1 (for example, on a hand), the base device including a first group 130 of identification blocks and the block of information preprocessing (not shown on FIG. 1), the computation block 140 containing blocks of processors, memories and the interface blocks with a possibility of providing communication (link) with the display 150, the groups 110, 120, 130 of the identification blocks and the display 150 with the group 160 of the identifications blocks, fixed on it, the base system 170 of coordinates, fixed to the first group 130 of identification blocks, the three-dimensional virtual space 180, objects 190 of the three-dimensional virtual space, the virtual pointer 200 of the preset position, relative to the base system of coordinates, length in the real three-dimensional space, the geometrical location 210 of cross points of the virtual pointer 200 with working area of the display 150, the image 220 on the display of the virtual pointer 200, the image 230 on the display of objects of the three-dimensional virtual space, the point 240 of interaction between the virtual pointer 200 with the objects 190 of the three-dimensional virtual space in the real three-dimensional space regarding the base system of coordinates, and the image 250 on the display of the point 240 of interaction of the virtual pointer 200 with the objects 190 of the three-dimensional virtual space. The virtual pointer can be such objects as a baseball bat, a stick, a classroom pointer, a pool cue, etc.

Also, FIG. 1 shows additional components that explain the mechanism of interaction with virtual objects according to the proposed method, namely, the graphic presentation of the virtual pointer 200, indicating intention of the user 1 to control the selected virtual object 190, an example 220 of displaying the selected virtual pointer on the display and an example of the visual effect 250 of the indicator impact on the selected virtual object. The virtual space 180 containing the virtual objects 190 is an array of the preset data relating to the image of the three-dimensional virtual objects saved in the memory of the computation block 140. Location of virtual objects 190 in the real space is carried out by means of setting up their coordinates regarding the base system 170 of coordinates disposed in the real space. The coordinates of the system components (displays (Xd, Yd, Zd), the virtual pointer fixing point (Xp, Yp, Zp), the origin of the base system (Xb, Yb, Zb) of coordinates in relation to the first group 130 of identification blocks, and others) are also contained in the memory of the computation block 140, and, if necessary, vary according to the algorithm described below. The coordinates of the virtual objects 190 in the real space—for example, coordinates (X_{V1}, Y_{V1}, Z_{V1}), (X_{V2}, Y_{V2}, Z_{V2}), • • • , (X_{VN}>Y_{VN}, Z_{VN}) shown in FIG. 1, are calculated on the basis of the relative coordinates of the virtual objects 190 in the virtual space, loaded in advance in the memory of the computation block 140, and of the real physical coordinates of the system components. The transformation of coordinates in the process of changing from the virtual system to the physical system is performed in accordance with the well known formulas of coordinate transformation.

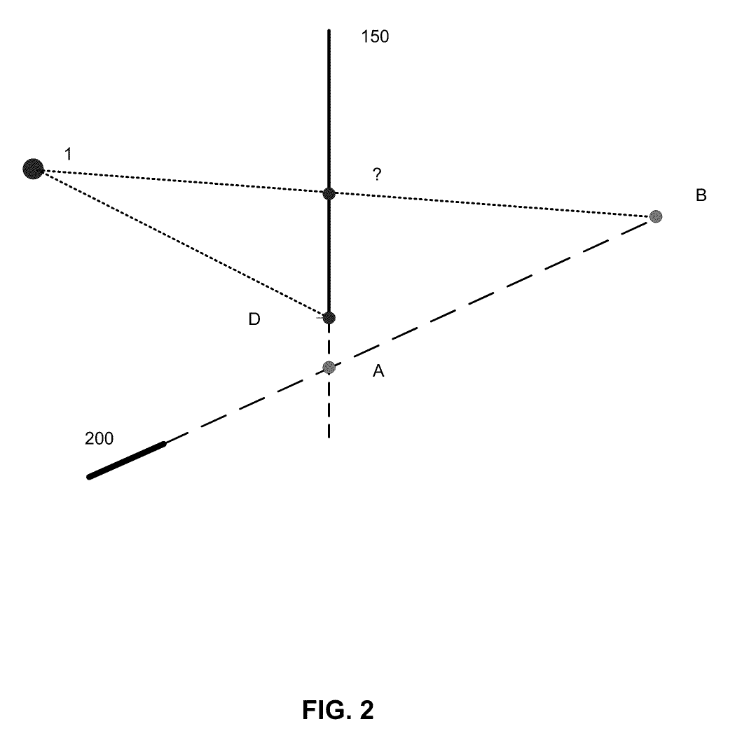

FIG. 2 illustrates the possibility of displaying the virtual pointer on the display screen (top view), also for a case where the virtual pointer moves to the side the display working area (zone). FIG. 2 also shows that the virtual pointer, while transiting through points A and B on the screen, is displayed in the form of the object transiting from point D to point C.

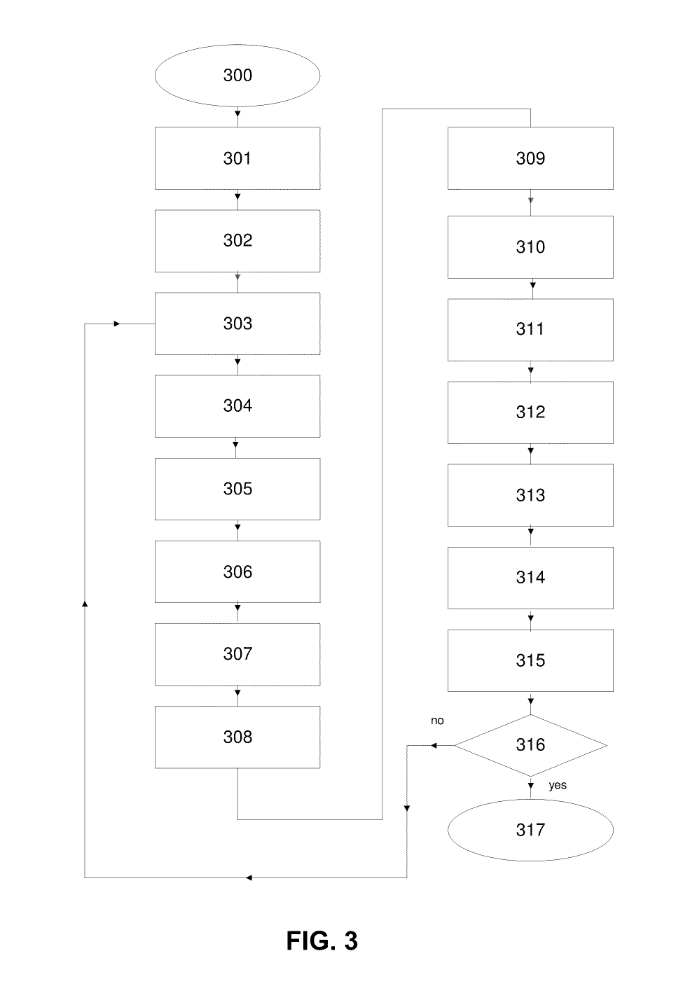

The algorithm (see FIG. 3) comprises the following steps:

300—start;

301—the first group of identification blocks is disposed in the real three-dimensional space;

302—the base system of the coordinates linked to the position in space of the identification blocks of the first group is created in the real three-dimensional space;

303—the second group of identification blocks, setting the position of the virtual pointer, thereby fixing a point in the real three-dimensional space, is disposed in the real three-dimensional space;

304—the third group of identification blocks, setting the position of the user view point of the working area of the displays in the real three-dimensional space, regarding the real physical base system of coordinates;

305—the coordinates of the three-dimensional virtual objects are created in advance in digital format in the real three-dimensional space and are set relative to the real physical base system of coordinates;

306—the coordinates of the working area of the displays in the real three-dimensional space are determined relative to the real physical base system of coordinates;

307—the user command to control the position or shape of the virtual pointer, or other outside (exterior) factors influencing the position or shape control of the virtual pointer, are analyzed;

308—the coordinates of the virtual pointer fixing point in real three-dimensional space relative to the base system of coordinates, are determined;

309—the coordinates of the constellation (collection) of the geometrical place of the virtual pointer points are set, with necessary detailing, relative to the virtual pointer fixing point;

310—the coordinates of the constellation (collection) of the geometrical location of the virtual pointer points in the real three-dimensional space, regarding the real physical base system of coordinates, are determined with necessary detailing, if they belong to the area of coordinates of the working area of the displays;

311—a collection of the virtual objects, whose coordinates in the real three-dimensional space belong to the area calculated with respect of the position of the geometrical place of the virtual pointer points belonging to the area of coordinates of the working area of displays;

312—the user command that is used to create the required collection (set) of the virtual operations, or other outside (exterior) factors that affect creation of the required collection of the virtual operations over virtual objects located within the working area of the virtual pointer, is analyzed;

313—the preset virtual operations to modify the virtual objects, are performed for all, or some of, the virtual objects from the generated collection of the virtual objects;

314—the array of the displayed data is modified by insertion of a displayed collection of the geometrical location of the virtual pointer points, and the current array of the displayed three-dimensional virtual objects is generated;

315—the generated array of the displayed data is shown on the display(s);

316—following the command to terminate operations, the process goes to step 317, otherwise it goes to step 303;

317—termination.

The proposed system describes one of the embodiments of the proposed method and to a person skilled in the art it should be clear that other kinds of hardware embodiment of the proposed method are also possible. In particular, the specific hardware implementation of the proposed method depends on the specific specifications of the identification blocks.

The identification block represents a device with a capability of receiving or transmitting, or receiving/transmitting, signals in one of the wavebands (ultrasonic, infrared, optical or wireless). Depending on the embodiment, such a device can be active or passive. Examples of implementation of ultrasonic receiver/transmitters, video-cameras, 3D video-cameras, as well as the transceivers operating in the radio frequency band, are generally known from the patent and technical literature. To select a specific design of the receiver/transmitters is not a problem for a skilled person. Depending on the selected type of the identification block, some other identification blocks (except the basic one) may be missing (eliminated) from the system.

The signals coming from the identification blocks operating in the transmission mode are received by the identification blocks operating in the receiving mode, and, after being processed in a computation device, are used for determination of the position of the working area of displays, the virtual pointer fixing points, and also (as an option) the position of the user view point of the working area of displays, relative to the real physical base system of coordinates.

The proposed method is based on the correct and exact determination of the above-stated coordinates of the system components. For example, where the identification block is based on video-cameras, the coordinates of a spatial object are calculated as follows (this represents a specific example of implementation of the theory known within the course of epipolar geometry):

Consider a situation where two cameras, located at different points, register the same scene. The pair of the images thus obtained is known as a stereo pair. Consider a case where identical cameras are located in such a way that their optical axes are parallel, and a straight line passing through their optical centers is perpendicular to the optical axes (this straight line is known as a base line, and its segment lying between the optical centers is know as a base). A more general case can be presented on the basis of this concept by applying the methods of conversion of coordinate systems and the methods of epipolar geometry.

Suppose the length of the base is equal to b. A global coordinate system shall be selected, whose starting point O is located on the base line in the middle point between optical centers of cameras, the axis OZ is parallel to the optical axes, and the axis OX is directed along the base line (see FIG. 3).

Assume that the starting points of the coordinates in the images planes of cameras coincide with the cross points of an optical axis with the image plane, and the units of coordinates in the global system and in the image planes of cameras are the same (identical).

Selecting a point with the global coordinates (X, Y, Z), coordinates of its projection in the image plane of the first (left) camera will be designated as (x′, y″) and in the image plane of the second (right) camera—as (x′, y″). (Projections of the same point on the planes of images of different cameras are known as conjugate points.). It is easy to see, that x′=f(X+b/2)/Z, x″=f(X−b/2)/Z, y′=y″=fY/Z.

Note that in the perpendicular direction to the direction of the base line, the coordinates of the conjugate points (y coordinates) coincide. This feature is of great importance for automated search for conjugate points on a stereo pair, as it provides an essential reduction of the sizes of the search range (zone). From the previous two correlations it follows, that

Z=fb/(x′−x″).

It means, that, assuming the geometry of the shot is known, and having performed measurement of the coordinates of the projections of the same point on the image planes of the cameras, it is possible to calculate the depth (Z coordinate) of this point. Moreover, thus generated correlations enable calculating all the three-dimensional coordinates of the point:

In an embodiment of the identification block on the basis of ultrasonic transceivers, the use of at least three receiver/transmitters enables achieving the enhanced precision, provided the spatial position of the receiver/transmitters is linked to a coordinate system, e.g., a real physical base system. The procedure for determining the coordinates of spatial objects for this particular case is disclosed in the published international patent application entitled “Method and system for visualization of virtual three-dimensional objects” (PCT/RU2005/000465). Thus, it is clear, that technical embodiment and practical application of the proposed method for producing an effect on virtual objects, are possible on the basis of the prior art. The novelty and non-obviousness of the claimed method are supported by application of the described concept of the precise spatial positioning of both the real physical and the virtually displayed objects in the real three-dimensional space regarding the real physical base system of coordinates, where the positioning offers new possibilities of operation with objects in a virtual reality. A detailed algorithm of implementation of the claimed method, for the case where it is applied in combination with the adaptive creation of a displayed collection of virtual objects on the basis of the analysis of the user (observer) position, will be considered below. The flowchart of the algorithm is presented in FIG. 3. Also, it is explained by functions of blocks 301-315 of the algorithm.

Some additional explanations are useful from the point of view of stating the new possibilities offered by the proposed method.

As noted earlier, the indicator (according to the proposed method) is positioned a real physical base system of coordinates, and all objects of the three-dimensional virtual space, together with the display, have the specific coordinates set in this real physical base system of coordinates. For example, the user has intention to perform an operation over the object of a virtual three-dimensional space, for example, the person shown on FIG. 1. The coordinates of the person (X_{V3}, Y_{V3}>Z_{V3}) are set in the real three-dimensional space regarding the real physical base system of coordinates. The distance from the user to the said person in the real world makes, for example 10 m (1000 cm). It is easily computed, as the coordinates of both the person (X_{V3}, Y_{V3}, Z_{V3}) and the user 1—(Xp, Yp, Zp), are known or can be determined by processing the signal coming from identification blocks (processing is carried out by one of the methods set forth above). The user 1 has possibility to set a certain scale—it can be set as scale 1:1 or any other scale.

For example, at usage of the scale set by the user and equal 1:20, the user wishing to touch a tree, should move the hand equipped with sensors of the second system of identification blocks, to the distance equal to 50 cm exactly.

If the scale is set as 1:1, all operations of the user with virtual objects will require performance of precisely same operations, as in case of handling the objects of the real physical space (or at producing an effect on such objects).

FIG. 1 shows that, though presentation 220 of the virtual pointer on the display is carried out in a two-dimensional plane of the display, all operations by the user will be carried out in a real physical coordinate system (optionally, taking into account the selected scale), that is presented on FIG. 1 image of the virtual pointer 200, which illustrates the user intention to control the selected virtual object 190.

This is an example that shows that the proposed method allows user training by, for example, a simulator where not only the necessary operations and manipulations with objects of the virtual world will be studied, but also the real dimensions of the environment where these operations are performed, will be reproduced accurately. It sharply boosts the learning efficiency of the user.

Thus, the proposed method is industrially applicable in training devices, simulators, computer games based on reality modeling, and in other applications.

While various embodiments of the present invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus, the present invention should not be limited by any of the above-described exemplary embodiments, but should be defined only in accordance with the following claims and their equivalents.

1-29. (canceled)

30. A method for producing an effect on virtual objects, the method comprising:
(a) placing a first group of identification blocks at corresponding coordinates in a real three-dimensional space;
(b) forming a base coordinate system in the real three-dimensional space, the base coordinate system linked to position of the first group of identification blocks;
(c) determining coordinates of working areas of displays in the real three-dimensional space, relative to the base coordinate system;
(d) setting coordinates of virtual objects in the real three-dimensional space, relative to the base coordinate system;
(e) placing a second group of identification blocks in the real three-dimensional space, the second group of identification blocks specifying an origin of a virtual pointer in the real three-dimensional space, relative to the base coordinate system;
(f) setting coordinates relative to the origin of a group of points that define the virtual pointer;
(g) determining the coordinates, in the real three-dimensional space, of the virtual pointer that fall within the working areas of the displays;
(h) determining a set of virtual objects whose coordinates overlap the coordinates of the virtual pointer determined in step (g);
(i) performing the specified modifications on the set of virtual objects determined in step (h).

31. The method of claim 30, further comprising placing a third group of identification blocks in the real three-dimensional space that identifies a user's view point.

32. The method of claim 30, wherein the virtual objects are modified based on (i) information about the working areas of the displays, (ii) location of the view point, and (iii) the coordinates of the virtual objects relative to each other.

33. The method of claim 30, wherein the second group of identification blocks is located on a user's body.

34. The method of claim 30, wherein the second group of identification blocks is moved randomly relative to the base coordinate system.

35. The method of claim 30, further comprising rotating the second group of identification blocks about at least one axis to thereby rotate the virtual pointer.

36. The method of claim 1, wherein the coordinates of the virtual pointer are modified based on input from sensors mounted on a user.

37. The method of claim 1, further comprising generating a mechanical effect in response to a change of shape or size of the virtual pointer.

38. The method of claim 1, wherein the modifications include generation of visual effects at areas overlapping or in contact with coordinates of the virtual pointer.

39. The method of claim 1, wherein the modifications are performed without showing the virtual pointer on the displays.

40. The method of claim 1, wherein the modifications include performing a visual, sound, mechanical or electromagnetic effect on the virtual objects.

41. The method of claim 1, wherein, to determine a location of the origin, the following steps are performed:
(i) setting a location of the origin relative to the second group of identification blocks;
(ii) determining a distance between the first and second groups of identifiers;
(iii) calculate coordinates of the second group of identification blocks based on the distance;
(iv) calculate a location of the origin based on information about location of the second group of identification blocks and location of the origin relative to the second group of identification blocks.

42. The method of claim 1, further comprising using any of the following for defining the groups of identifiers: ultrasound transceivers, optical transceivers, radio transceivers, and infrared transceivers.

43. The method of claim 1, wherein the second group of identification blocks includes a marker identified by processing optical or infrared data.
